(19) United States
(12) Patent Application Publication
(10) Pub. No.: US 2024/0182165 A1
(43) Pub. Date: Jun. 6, 2024

(54) SYSTEMS AND METHODS FOR TILTROTOR ROTOR TILTING WITH AERODYNAMIC SURFACES

(71) Applicant: Donatas Skulskis, Siauliai (LT)

(72) Inventor: Donatas Skulskis, Siauliai (LT)

(21) Appl. No.: 18/073,926

(22) Filed: Dec. 2, 2022

(51) Int. Cl. B64C 29/00

(52) U.S. Cl. CPC B64C 29/0033

(57) ABSTRACT

A tiltrotor rotor tilting system for an aircraft includes a fixed wing, an engine nacelle rotatably connected to the fixed wing, and a propellor connected to the engine nacelle. The propellor is configured to generate airflow. The engine nacelle includes a first engine nacelle flap pivotably connected to the engine nacelle and a first moveable joint. The first movable joint is configured to pivot the first engine nacelle flap from a stowed flap position to a deployed flap position. The engine nacelle is configured to tilt from a first nacelle position to a second nacelle position relative to the fixed wing in response to the airflow contacting the first engine nacelle flap while in the deployed flap position.

### TECHNICAL FIELD

The present disclosure relates to tiltrotor rotor tilting for an aircraft. More specifically, the present disclosure relates to an aerodynamic system for tiltrotor rotor tilting in a vertical take-off and landing (VTOL) aircraft.

### BACKGROUND

A vertical take-off and landing (VTOL) aircraft is an aircraft which is capable of taking off, hovering, and landing vertically. The current state of the art in VTOL propulsion encompasses various tiltrotor propulsion systems and methods, which typically require cumbersome mechanical actuators to enable tilting. Overall, current systems and methods are heavy, complex, and costly.

Accordingly, developments in efficient propulsion and stability for tiltrotor aircraft are needed.

### SUMMARY

In accordance with aspects of the disclosure, a tiltrotor rotor tilting system for an aircraft includes a fixed wing, an engine nacelle rotatably connected to the fixed wing, and a propellor operably connected to the engine nacelle by a shaft. The propellor is configured to generate airflow. The engine nacelle includes a first engine nacelle flap pivotably connected to the engine nacelle and a rotational device. The rotational device is configured to pivot the first engine nacelle flap from a stowed flap position to a deployed flap position. The engine nacelle is configured to tilt from a first nacelle position to a second nacelle position relative to the fixed wing in response to the airflow contacting the first engine nacelle flap while in the deployed flap position.

In an aspect of the present disclosure, the engine nacelle may be rotatably connected to the fixed wing by a rotational device at a center of gravity of the engine nacelle.

In another aspect of the present disclosure, the engine nacelle may be rotatably connected to the fixed wing by a rotational device outside of a center of gravity of the engine nacelle, causing the engine nacelle to tilt into a perpendicular position relative to the fixed wing.

In yet another aspect of the present disclosure, the engine nacelle flap may be disposed on an outer surface of the engine nacelle. In the stowed flap position, the engine nacelle flap may be disposed in substantial alignment with the outer surface of the engine nacelle.

In a further aspect of the present disclosure, in the deployed flap position, the engine nacelle flap may be disposed in substantial unalignment with the outer surface of the engine nacelle.

In yet a further aspect of the present disclosure, the engine nacelle flap may be disposed on an inner surface of the engine nacelle. In the stowed flap position, the engine nacelle flap may be retracted substantially within the engine nacelle.

In an aspect of the present disclosure, in the deployed flap position, the engine nacelle flap may be substantially expanded outwards from within the engine nacelle.

In another aspect of the present disclosure, the system may further include a second engine nacelle flap pivotably connected to the engine nacelle and a second moveable joint. The second moveable joint may be configured to pivot the second engine nacelle flap from a stowed flap position to a deployed flap position. The engine nacelle may be configured to tilt from a third nacelle position to a fourth nacelle position relative to the fixed wing in response to the airflow contacting the second engine nacelle flap while in the deployed flap position.

In accordance with aspects of the present disclosure, a tiltrotor rotor tilting system for an aircraft includes a fixed wing, an engine nacelle rotatably connected to the fixed wing, a propellor operably connected to the engine nacelle by a shaft, a rotor control system, a processor, and a memory. The engine nacelle includes an inlet duct and a first exhaust outlet. The inlet duct is configured to receive an airflow. The first exhaust outlet is configured to direct the airflow and includes a first actuator disposed in the first exhaust outlet. The first actuator is configured to direct the airflow out of the first exhaust outlet in a first direction. The propellor is configured to generate the airflow. The memory includes instructions that, when executed by the processor, cause the system to: receive, by the inlet duct, the airflow from the propellor through the first exhaust outlet; actuate the first actuator from a closed position to an open position in response to the rotor control system; direct the airflow out of the first exhaust outlet in the first direction in response to actuation of the first actuator; and tilt the engine nacelle from a first nacelle position to a second nacelle position relative to the fixed wing in response to the airflow out of the first exhaust outlet in the first direction.

In yet another aspect of the present disclosure, the system may include a second actuator disposed in the first exhaust outlet. The second actuator may be configured to direct the airflow out of the first exhaust outlet in a second direction. The instructions when executed by the processor may further cause the system to: receive, by the inlet duct, the airflow from the propellor through the first exhaust outlet; actuate the second actuator from a closed position to an open position in response to the rotor control system; direct the airflow out of the first exhaust outlet in the second direction in response to actuation of the second actuator; and tilt the engine nacelle from a third nacelle position to a fourth nacelle position relative to the fixed wing in response to the airflow out of the first exhaust outlet in the second direction.

In a further aspect of the present disclosure, the system may include a second exhaust outlet. The second exhaust outlet may include a third actuator disposed in the second exhaust outlet. The third actuator may be configured to direct the airflow out of the second exhaust outlet in a third direction. The instructions when executed by the processor may further cause the system to: receive, by the inlet duct, the airflow from the propellor through the second exhaust outlet; actuate the third actuator from a closed position to an open position in response to the rotor control system; direct the airflow out of the second exhaust outlet in the third direction in response to actuation of the third actuator; and tilt the engine nacelle from a fifth nacelle position to a sixth nacelle position relative to the fixed wing in response to the airflow out of the second exhaust outlet in the third direction.

In yet a further aspect of the present disclosure, the system may include a fourth actuator disposed in the second exhaust outlet. The fourth actuator may be configured to direct the airflow out of the second exhaust outlet in a fourth direction. The instructions when executed by the processor may further cause the system to: receive, by the inlet duct, the airflow from the propellor through the second exhaust outlet; actuate the fourth actuator from a closed position to an open position in response to the rotor control system; direct the airflow out of the second exhaust outlet in the fourth direction in response to actuation of the fourth actuator; and tilt the engine nacelle from a seventh nacelle position to an eighth nacelle position relative to the fixed wing in response to the airflow out of the second exhaust outlet in the fourth direction.

In accordance with aspects of the present disclosure, a method for a tiltrotor rotor tilting system for an aircraft includes: receiving, by an inlet duct of an engine nacelle of the aircraft, an airflow from a propellor of the engine nacelle through a first exhaust outlet of the engine nacelle; actuating a first actuator of the first exhaust outlet from a closed position to an open position in response to a rotor control system; directing the airflow out of the first exhaust outlet in a first direction in response to actuation of the first actuator; and tilting the engine nacelle from a first nacelle position to a second nacelle position relative to a fixed wing of the aircraft in response to the airflow out of the first exhaust outlet in the first direction.

In an aspect of the present disclosure, tilting the engine nacelle from the first nacelle position to the second nacelle position may include tilting the engine nacelle using a rotational device to rotatably connect the engine nacelle to the fixed wing at a center of gravity of the engine nacelle.

In another aspect of the present disclosure, tilting the engine nacelle from the first nacelle position to the second nacelle position may include tilting the engine nacelle using a rotational device to rotatably connect the engine nacelle to the fixed wing outside of a center of gravity of the engine nacelle. The second nacelle position may be a perpendicular position relative to the fixed wing.

In yet another aspect of the present disclosure, the method may further include: receiving, by the inlet duct, the airflow from the propellor through the first exhaust outlet; actuating a second actuator from a closed position to an open position in response to the rotor control system; directing the airflow out of the first exhaust outlet in a second direction in response to actuation of the second actuator; and tilting the engine nacelle from a third nacelle position to a fourth nacelle position relative to the fixed wing in response to the airflow out of the first exhaust outlet in the second direction.

In a further aspect of the disclosure, the method may further include: receiving, by the inlet duct, the airflow from the propellor through a second exhaust outlet; actuating a third actuator from a closed position to an open position in response to the rotor control system; directing the airflow out of the second exhaust outlet in a third direction in response to actuation of the third actuator; and tilting the engine nacelle from a fifth nacelle position to a sixth nacelle position relative to the fixed wing in response to the airflow out of the second exhaust outlet in the third direction.

In yet a further aspect of the present disclosure, the method may further include: receiving, by the inlet duct, the airflow from the propellor through the second exhaust outlet; actuating a fourth actuator from a closed position to an open position in response to the rotor control system; directing the airflow out of the second exhaust outlet in a fourth direction in response to actuation of the fourth actuator; and tilting the engine nacelle from a seventh nacelle position to an eighth nacelle position relative to the fixed wing in response to the airflow out of the second exhaust outlet in the fourth direction.

In accordance with aspects of the present disclosure, a tiltrotor rotor tilting system for an aircraft includes a fixed wing and an engine rotatably connected to the fixed wing. The engine includes a body, a propellor operably coupled to the body by a shaft, and a flap. The flap is configured to move relative to the body to tilt the engine relative to the fixed wing.

In an aspect of the present disclosure, the aircraft may be a vertical take-off and landing (VTOL) aircraft.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a top perspective view of a tiltrotor rotor tilting system of an aircraft, in accordance with the present disclosure;

FIG. 2 is a top perspective view of the tiltrotor rotor tilting system of the aircraft of FIG. 1 with engine nacelle flaps in an alternative position, in accordance with the present disclosure;

FIG. 3 is a top perspective view of the tiltrotor rotor tilting system of the aircraft of FIG. 1 with the engine nacelle flaps in another alternative position, in accordance with the present disclosure.

FIG. 4 is a side view of the tiltrotor rotor tilting system of the aircraft of FIG. 1, in accordance with the present disclosure;

FIGS. 5A-5C are side views of an engine nacelle of the tiltrotor rotor tilting system of the aircraft of FIGS. 1-4 using aerodynamic tilting, in accordance with the present disclosure;

FIG. 6 is a side perspective view of another example of a tiltrotor rotor tilting system of an aircraft, in accordance with the present disclosure;

FIG. 7 is a top view of the tiltrotor rotor tilting system of the aircraft of FIG. 6, in accordance with the present disclosure;

FIGS. 8A-8D are side views of an engine nacelle of the tiltrotor rotor tilting system of the aircraft of FIGS. 6 and 7 using aerodynamic tilting, in accordance with the present disclosure;

FIG. 9 is a side view of another example of a tiltrotor rotor tilting system of an aircraft, in accordance with the present disclosure;

FIG. 10 is a top view of the tiltrotor rotor tilting system of the aircraft of FIG. 9, in accordance with the present disclosure;

FIG. 11 is a top view of the tiltrotor rotor tilting system of the aircraft of FIG. 9 with engine nacelle flaps in an alternative position, in accordance with the present disclosure;

FIG. 12 is a side view of another example of a tiltrotor rotor tilting system of an aircraft, in accordance with the present disclosure;

FIG. 13 is an engine nacelle with exhaust pipes, in accordance with the present disclosure;

FIG. 14 is a side view of the tiltrotor rotor tilting system of the aircraft of FIG. 12, with an engine nacelle in an alternative position, in accordance with the present disclosure;

FIG. 15 is a side view the tiltrotor rotor tilting system of the aircraft of FIG. 12, with the engine nacelle in another alterative position, in accordance with the present disclosure;

FIG. 16 is a flow diagram of a method for a tiltrotor rotor tilting system for an aircraft, in accordance with the present disclosure; and

FIG. 17 is a block diagram of a controller configured for use with a tiltrotor rotor tilting system of an aircraft, in accordance with the present disclosure.

Further details and aspects of exemplary aspects of the present disclosure are described in more detail below with reference to the appended figures. Any of the above aspects and aspects of the present disclosure may be combined without departing from the scope and spirit of the present disclosure.

### DETAILED DESCRIPTION

The present disclosure relates to a tiltrotor rotor tilting for an aircraft. More specifically, the present disclosure relates to a system for tiltrotor rotor tilting with aerodynamic surfaces, which is generally incorporated into a vertical take-off and landing (VTOL) aircraft.

Although the present disclosure will be described in terms of specific aspects, it will be readily apparent to those skilled in the art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

An aerodynamic tiltrotor rotor tilting system (ARTS), as disclosed herein, simplifies and enhances the reliability of the tiltrotor propellor/rotor tilting process. Unlike regular, mechanical systems, ARTS uses aerodynamic forces (e.g., airflow from the propellors/rotors) to redirect airflow to tilt the tiltrotor propellors/rotors with the engines to the desirable position (e.g., tilting the engine nacelle into a position in response to the airflow). Unlike complex, mechanical rotor tilting systems located inside the tiltrotor wing, the majority of ARTS aerodynamic tilting system components are located inside the engine nacelle.

Overall, the disclosed technology enables lighter construction of tiltrotor rotor tilting systems than traditional methods. Further, the disclosed technology has the benefit of less complex, moving parts and less expensive components.

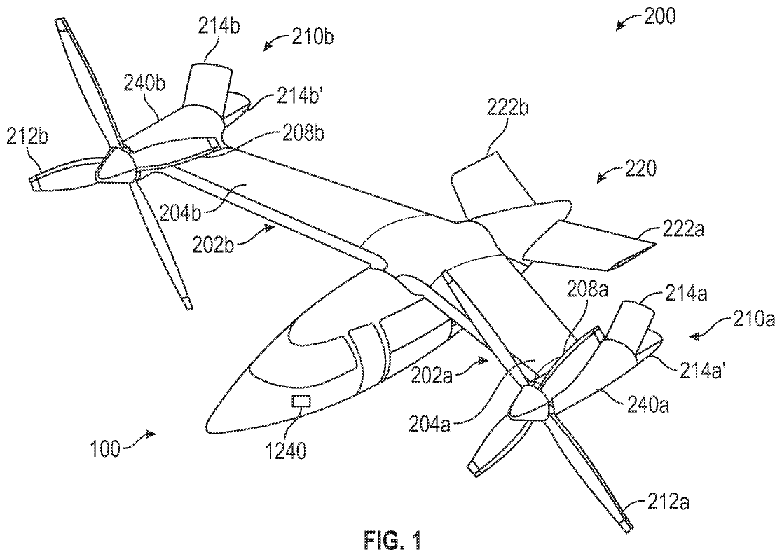

Referring to FIGS. 1-4, there are shown illustrations of an exemplary tiltrotor rotor tilting system 200 of an aircraft 100 in accordance with aspects of the present disclosure. The aircraft 100 contains a fuselage 102 including a front portion 102a and a rear portion 102b. The system 200 of the aircraft 100 includes a rotor control system 1240, fixed wings 202a, 202b, engine nacelles 210a, 210b, propellors 212a, 212b, and a rear stabilizer system 220. The rear stabilizer system 220 may be disposed in the rear portion 102b of the fuselage 102, and the rotor control system 1240 may be disposed in the front portion 102a of the fuselage 102, although alternative placements are envisioned. The fuselage 102 is configured to handle high twist torque. The rear stabilizer system 220 contains rear rudders 222a, 222b configured to stabilize flight.

The fixed wings 202a, 202b may contain wing tips 204a, 204b. In aspects, the fixed wings 202a, 202b further include a driveshaft, a shaft support, and a conversion spindle (not pictured). The engine nacelles 210a, 210b may be rotatably connected to the fixed wings 202a, 202b by a rotational device 208a, 208b. In aspects, the engine nacelles 210a, 210b may be mounted to the fixed wings 202a, 202b by the rotational device 208a, 208b at a center of gravity 218a, 218b of the engine nacelles 210a, 210b, although various alternative positions are envisioned, as discussed below. In aspects, the engine nacelles 210a, 210b include pylon mounted driveshafts, proprotor gear boxes, and tilt-axis gearboxes (not pictured). The pylon mounted driveshafts may be orientated parallel or perpendicular to the fuselage, lightweight, and/or configured to produce torque to turn the propellors 212a, 212b. The engine nacelles 210a, 210b may have a variety of shapes, generally including a substantially oblong or cylindrical shape, and may be made of metals, polymers, composite, and/or any other materials widely used in the relevant arts.

Engine nacelles 210a, 210b are configured to generate lift. The engine nacelles 210a, 210b may powered by a fuel/power source for driving the tiltrotor rotor tilting system 200. The fuel/power source may include any suitable power source and/or fuel for powering the engines and control systems of the aircraft 100. For example, the tiltrotor rotor tilting system 200 may include internal combustion engines, hydrogen, and/or electric motors, or any combination thereof.

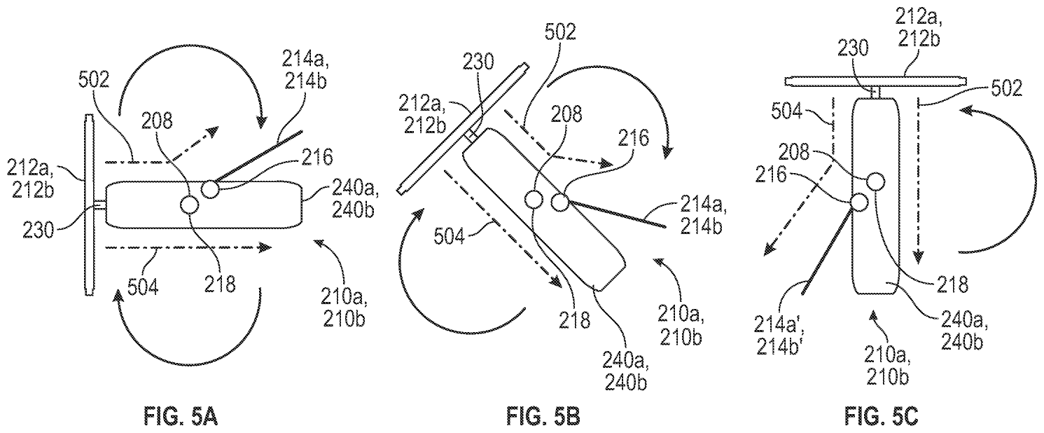

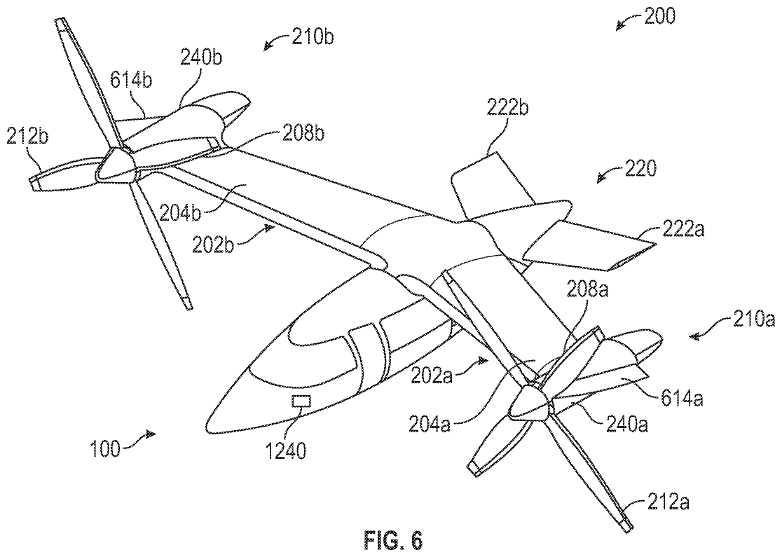

Propellors 212a, 212b are configured to generate airflow. Propellors 212a, 212b may be operably connected to the engine nacelles 210a, 210b by a shaft 230. The engine nacelles 210a, 210b may include engine nacelle flaps 214a, 214a′, 214b, 214b′ pivotably connected to the engine nacelles 210a, 210b. In aspects, the engine nacelle flaps 214a, 214a′, 214b, 214b′ may have aerodynamic surfaces configured to direct the airflow 502, 504 from the propellors 212a, 212b to the engine nacelle flaps 214a, 214a′, 214b, 214b′ (FIGS. 5A-5C). While four engine nacelle flaps 214a, 214a′, 214b, 214b′ are pictured on the aircraft 100, any suitable number may be present. In aspects, the engine nacelle flaps 214a, 214a′, 214b, 214b′ may be disposed on a rear portion of the engine nacelles 210a, 210b (FIGS. 1-4), although alternate placements are envisioned. For example, the engine nacelle flaps 214a, 214a′, 214b, 214b′ may be disposed in any suitable position along a length of a top or bottom surface of the engine nacelles 210a, 210b (FIGS. 6,7).

Referring to FIGS. 5A-5C, the engine nacelle flaps 214a, 214a′, 214b, 214b′ are shown disposed on the engine nacelles 210a, 210b. While shown with only one engine nacelle flap 214a, 214a′, 214b, 214b′ for clarity, it is envisioned that multiple engine nacelle flaps 214a, 214a′, 214b, 214b′ may be present. A moveable joint 216 may be configured to pivot the engine nacelle flaps 214a, 214a′, 214b, 214b′ from a stowed flap position to a deployed flap position. In the deployed flap position, the airflow 502, 504 generated by the propellors 212a, 212b may contact the engine nacelle flaps 214a, 214a′, 214b, 214b′, causing the engine nacelles 210a, 210b to tilt. In aspects, the moveable joint 216 may actuate the engine nacelle flaps 214a, 214a′, 214b, 214b′ in response to the rotor control system 1240. In aspects, the moveable joint 216 enables pivoting of the engine nacelle flaps 214a, 214a′, 214b, 214b′ along a single axis, although pivoting along multiple axes is also envisioned. The engine nacelle flaps 214a, 214a′, 214b, 214b′ may pivot on the moveable joint 216 using shoulder length differences based on a center of gravity 218a, 218b of the engine nacelles 210a, 210b. In aspects, the engine nacelle flaps 214a, 214a′, 214b, 214b′ may cause the engine nacelles 210a, 210b to rotate in a clockwise direction (FIGS. 5A, 5B) or a counterclockwise direction (FIG. 5C) relative to the fixed wings 202a, 202b in response to the airflow 502, 504.

In aspects, the engine nacelle flaps 214a, 214a′, 214b, 214b′ may pivot at different angles based on the placement of the engine nacelle flaps 214a, 214a′, 214b, 214b′ relative to the engine nacelles 210a, 210b. For example, the engine nacelle flaps 214a, 214a′, 214b, 214b′ may pivot at a higher angle when placed on a front portion of the engine nacelles 210a, 210b because the engine nacelle flaps 214a, 214a′, 214b, 214b′ require less force to pivot.

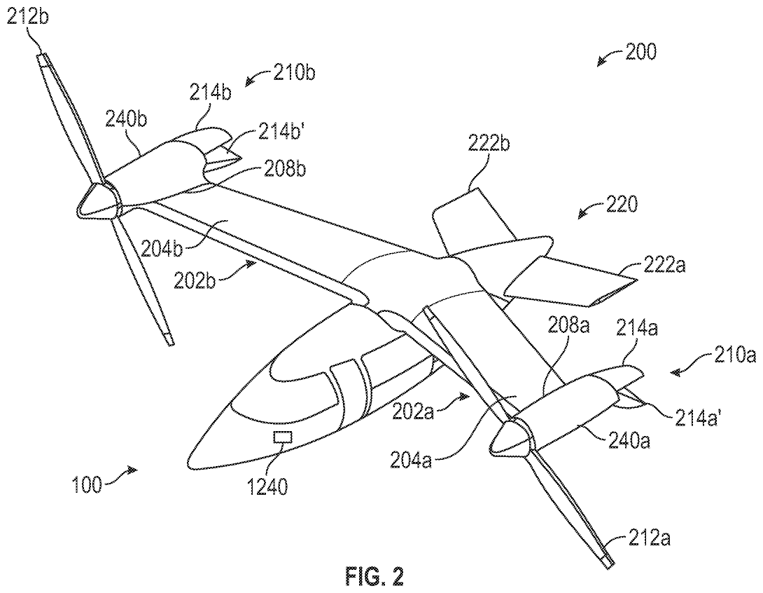

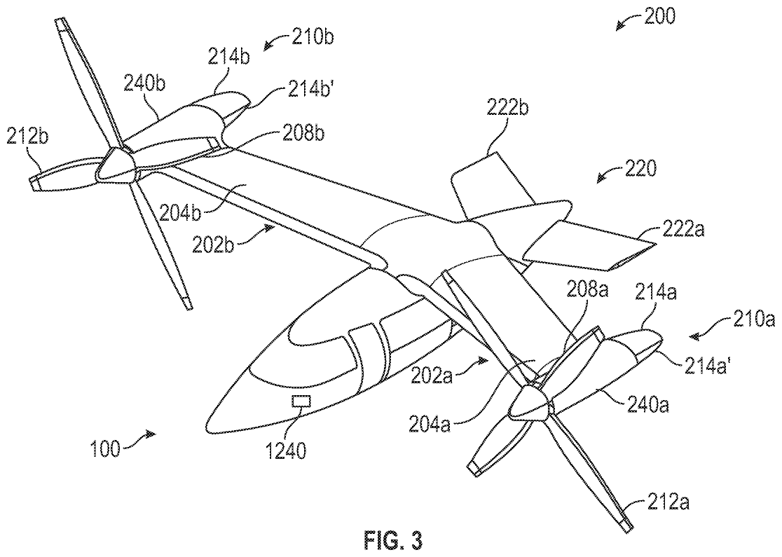

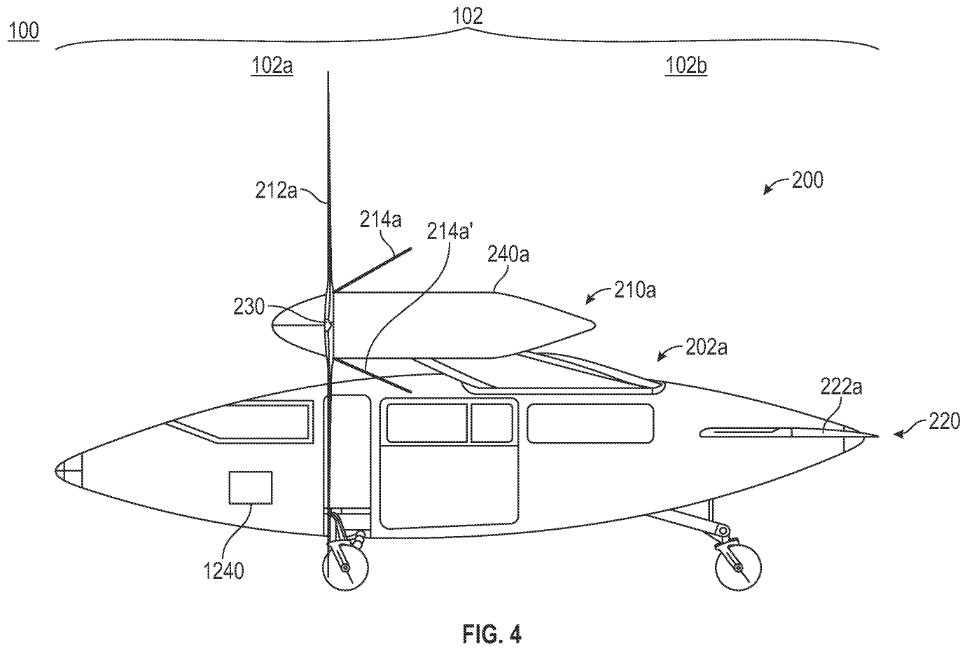

With further reference to FIGS. 1-4, in aspects, the engine nacelle flaps 214a, 214a′, 214b, 214b′ may be disposed on an outer surface 240a, 240b of the engine nacelles 210a, 210b. In aspects, when in the stowed flap position, the engine nacelle flaps 214a, 214a′, 214b, 214b′ may be disposed in substantial alignment with the outer surface 240a, 240b of the engine nacelle. When in the deployed flap position, the engine nacelle flaps 214a, 214a′, 214b, 214b′ may be disposed in substantial unalignment with the outer surface 240a, 240b of the engine nacelle. For example, the engine nacelle flaps 214a, 214a′, 214b, 214b′ may rotate through an arc length ranging from about zero degrees to about 90 degrees with respect to the engine nacelles 210a, 210b, where the arc length extends on an axis perpendicular to the engine nacelles 210a, 210b. As an illustrative example, the engine nacelle flaps 214a, 214a′, 214b, 214b′ may be at about a zero-degree angle when in the stowed flap position, and at about a 90-degree angle when in the deployed flap position, although various positions/angles are envisioned. For example, in FIG. 4, the engine nacelle flaps 214a, 214a′ are at about a 45-degree angle and are in the deployed flap position. In aspects, the engine nacelle flaps 214a, 214a′, 214b, 214b′ may work in pairs, allowing the flaps to be configured in various position combinations. For example, a first pair of engine nacelle flaps 214a, 214b may be in the first nacelle position and a second pair of engine nacelle flaps 214a′, 214b′ may be in the second nacelle position (FIG. 1), or vice versa (FIG. 2). Alternatively, both the first pair of engine nacelle flaps 214a, 214b and the second pair of engine nacelle flaps 214a′, 214b′ may be in the first nacelle position (FIG. 4) or the second nacelle position (FIG. 3).

The engine nacelles 210a, 210b may be configured to aerodynamically tilt from a first nacelle position to a second nacelle position, and vice versa, relative to the fixed wings 202a, 202b in response to the airflow 502, 504 contacting the engine nacelle flaps 214a, 214a′, 214b, 214b′ while in the deployed flap position. For example, when engine nacelle flap 214a is in the deployed flap position and engine nacelle flap 214a′ is in the stowed flap position, airflow 502 will contact the engine nacelle flap 214a, causing engine nacelle 210a to tilt in a clockwise direction from the first nacelle position to the second nacelle position (FIGS. 5A, 5B). In another example, when engine nacelle flap 214a′ is in the deployed flap position and engine nacelle flap 214a is in the stowed flap position, airflow 504 will contact the engine nacelle flap 214a′, causing engine nacelle 210a to tilt in a counterclockwise direction from the second nacelle position to the first nacelle position (FIG. 5C). While illustrated in the above examples as clockwise and counterclockwise movement, various additional angles and/or rotational capacities are also envisioned. Likewise, various alternative positions/configurations of the engine nacelle flaps 214a, 214a′, 214b, 214b′ may enable various alternative positions of the engine nacelles 210a, 210b.

In aspects, when in the first nacelle position, the engine nacelles 210a, 210b may be disposed in substantial alignment with the fixed wings 202a, 202b. When in the second nacelle position, the engine nacelles 210a, 210b may be disposed in substantial unalignment with the fixed wings 202a, 202b. For example, the engine nacelles 210a, 210b may rotate through an arc length ranging from about zero degrees to about 180 degrees with respect to the fixed wings 202a, 202b, where the arc length extends on an axis perpendicular to the fixed wings 202a, 202b. As an illustrative example, the engine nacelles 210a, 210b may be at about a zero-degree angle when in the first nacelle position, and at about a 90-degree angle when in the second nacelle position, although various positions/angles are envisioned including full 180-degree rotation. For example, in FIG. 4, the engine nacelle 210a is shown at about a zero-degree angle when in the first nacelle position.

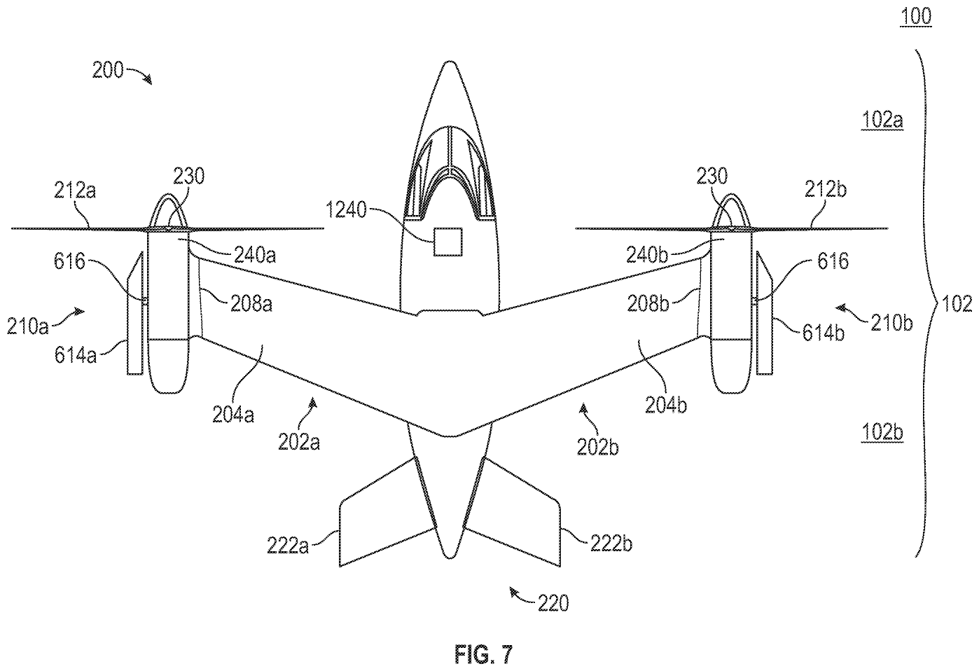

Referring to FIGS. 6 and 7, engine nacelle flaps 614a, 614b may be mounted to the engine nacelles 210a, 210b by a moveable joint 616 on a side portion of the engine nacelles 210a, 210b. In aspects, the moveable joint 616 is disposed in a position parallel to the rotational device 208a, 208b that mounts the engine nacelles 210a, 210b to the fixed wings 202a, 202b. The engine nacelle flaps 614a, 614b may pivot about the moveable joint 616 in a clockwise or counterclockwise direction in response to the airflow 802, 804.

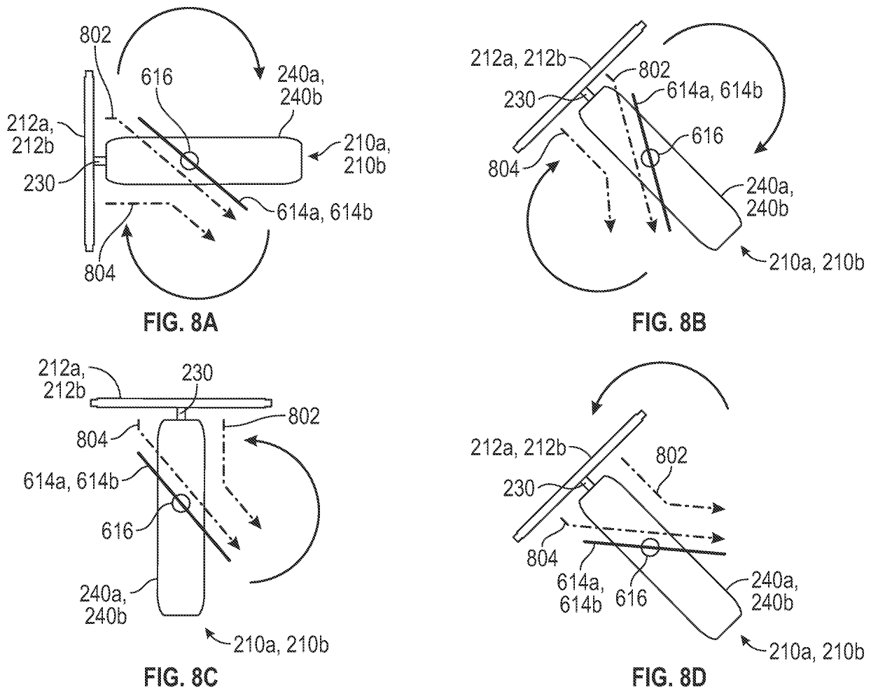

Referring to FIGS. 8A-8D, the engine nacelle flaps nacelle flaps 614a, 614b are shown disposed on the engine nacelles 210a, 210b. The moveable joint 616 may be configured to pivot the engine nacelle flaps 614a, 614b from a stowed flap position to a deployed flap position. In the deployed flap position, the airflow 802, 804 generated by the propellors 212a, 212b may contact the engine nacelle flaps 614a, 614b, causing the engine nacelles 210a, 210b to tilt. In aspects, the moveable joint 616 may actuate the engine nacelle flaps 614a, 614b in response to the rotor control system 1240. In aspects, the moveable joint 616 enables pivoting of the engine nacelle flaps 614a, 614b along a single axis, although pivoting along multiple axes is also envisioned. In aspects, the engine nacelle flaps 614a, 614b may cause the engine nacelles 210a, 210b to rotate in a clockwise direction (FIGS. 8A, 8B) or a counterclockwise direction (FIGS. 8C, 8D) relative to the fixed wings 202a, 202b in response to the airflow 802, 804.

The engine nacelle flaps 614a, 614b may be disposed on the outer surface 240a, 240b of the engine nacelles 210a, 210b. In aspects, when in the stowed flap position, the engine nacelle flaps 614a, 614b may be disposed in substantial alignment with the outer surface 240a, 240b of the engine nacelle. When in the deployed flap position, the engine nacelle flaps 614a, 614b may be disposed in substantial unalignment with the outer surface 240a, 240b of the engine nacelle. For example, the engine nacelle flaps 614a, 614b may rotate through an arc length ranging from about zero degrees to about 90 degrees with respect to the engine nacelles 210a, 210b, where the arc length extends on an axis perpendicular to the engine nacelles 210a, 210b. As an illustrative example, the engine nacelle flaps 614a, 614b may be at about a zero-degree angle when in the stowed flap position, and at about a 90-degree angle when in the deployed flap position, although various positions/angles are envisioned.

In aspects, the engine nacelles 210a, 210b may be configured to aerodynamically tilt from a first nacelle position to a second nacelle position relative to the fixed wings 202a, 202b in response to the airflow 802, 804 contacting the engine nacelle flaps 614a, 614b while in the deployed flap position. For example, when engine nacelle flaps 614a, 614b are in a first deployed flap position, airflow 802 will contact the engine nacelle flaps 614a, 614b, causing engine nacelles 210a, 210b to tilt in a clockwise direction from the first nacelle position to the second nacelle position (FIGS. 8A, 8B). In another example, when engine nacelle flaps 614a, 614b are in a second deployed flap position, airflow 804 will contact the engine nacelle flaps 614a, 614b, causing engine nacelles 210a, 210b to tilt in a counterclockwise direction from the second nacelle position to the first nacelle position (FIGS. 8C, 8D). While illustrated in the above examples as clockwise and counterclockwise movement, various additional angles and/or rotational capacities are also envisioned. Likewise, various alternative positions/configurations of the engine nacelle flaps 614a, 614b may enable various alternative positions of the engine nacelles 210a, 210b.

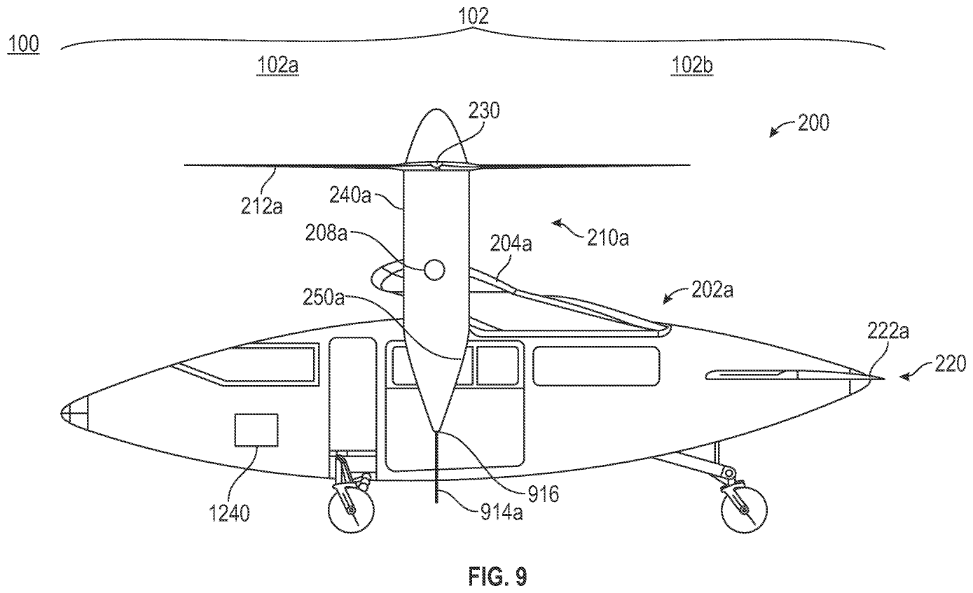

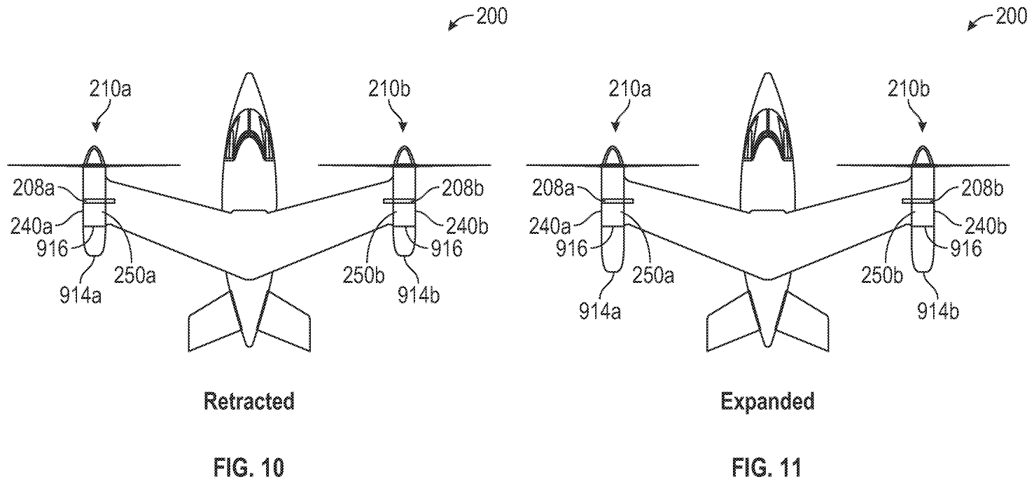

Referring to FIGS. 9-11, engine nacelle flaps 914a, 914b may be mounted to the engine nacelles 210a, 210b by a moveable joint 916 on a rear portion of the engine nacelles 210a, 210b. The engine nacelle flaps 914a, 914b may pivot about the moveable joint 916 in a clockwise or counterclockwise direction in response to airflow. The moveable joint 916 may be configured to pivot the engine nacelle flaps 914a, 914b from a stowed flap position to a deployed flap position. In the deployed flap position, the airflow generated by the propellors 212a, 212b may contact the engine nacelle flaps 914a, 914b, causing the engine nacelles 210a, 210b to tilt. In aspects, the moveable joint 916 may actuate the engine nacelle flaps 914a, 914b in response to the rotor control system 1240. In aspects, the moveable joint 916 enables pivoting of the engine nacelle flaps 914a, 914b along a single axis, although pivoting along multiple axes is also envisioned. In aspects, the engine nacelle flaps 914a, 914b may cause the engine nacelles 210a, 210b to rotate in a clockwise direction or a counterclockwise direction relative to the fixed wings 202a, 202b in response to the airflow. The engine nacelle flaps 914a, 914b may be disposed on an inner surface 250a, 250b of the engine nacelles 210, 210b. In aspects, when in the stowed flap position (FIG. 10), the engine nacelle flaps 914a, 914b may be retracted substantially within the engine nacelles 210a, 210b. When in the deployed flap position (FIG. 11), the engine nacelle flaps 914a, 914b may be expanded substantially outwards from within the engine nacelles 210a, 210b. In aspects, the engine nacelles 210a, 210b may be configured to aerodynamically tilt from a first nacelle position to a second nacelle position relative to the fixed wings 202a, 202b in response to the airflow contacting the engine nacelle flaps 614a, 614b while in the deployed flap position.

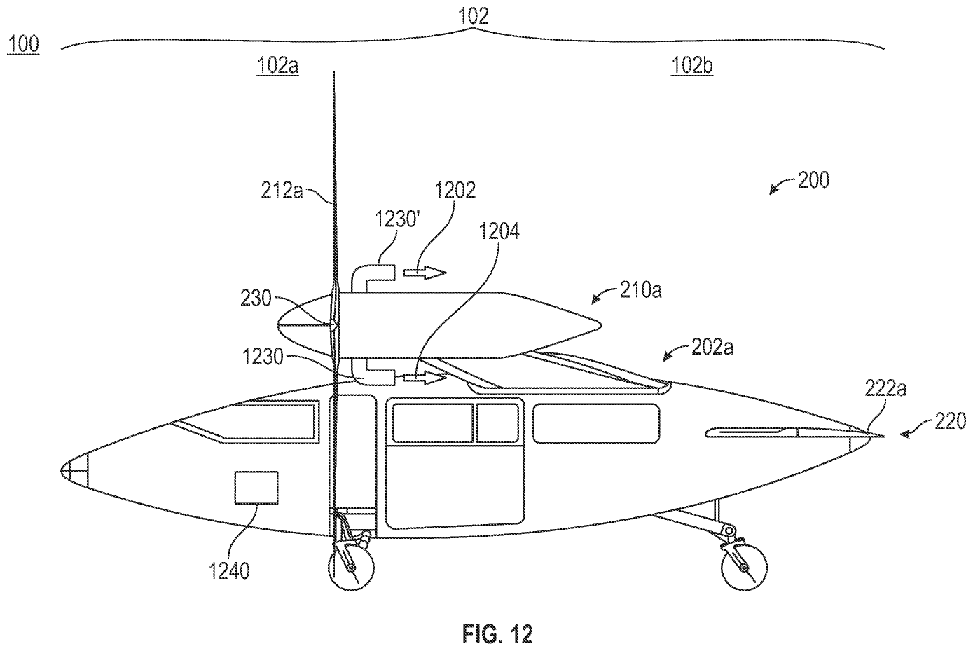

Referring to FIGS. 12-15, the engine nacelles 210a, 210b may include an inlet duct 1216 and exhaust pipes 1230, 1230′ containing exhaust outlets 1232, 1232′, 1234, 1234′. The exhaust pipes 1230, 1230′ may be disposed on a portion of the engine nacelles 210a, 210b. The inlet duct 1216 may be configured to receive airflow 1202, 1204 from the propellors 212a, 212b. Rotor control system 1240 may be configured to actuate the actuators 1236, 1236′, 1238, 1238′. The engine nacelles 210a, 210b may be configured to aerodynamically tilt from the first nacelle position to the second nacelle position relative to the fixed wings 202a, 202b in response to the airflow 1202, 1204 out of the exhaust outlets 1232, 1232′, 1234, 1234′.

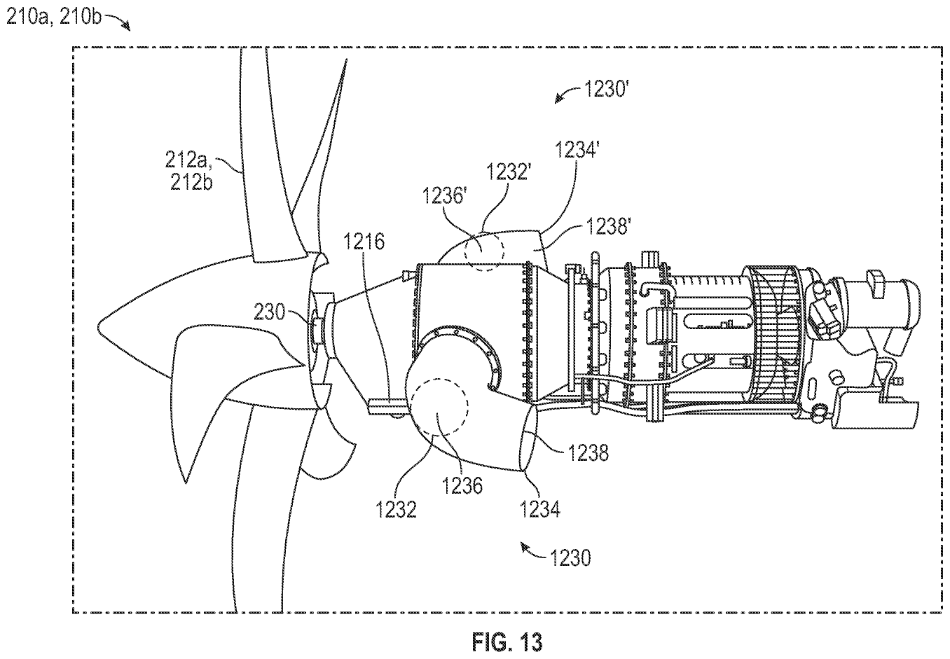

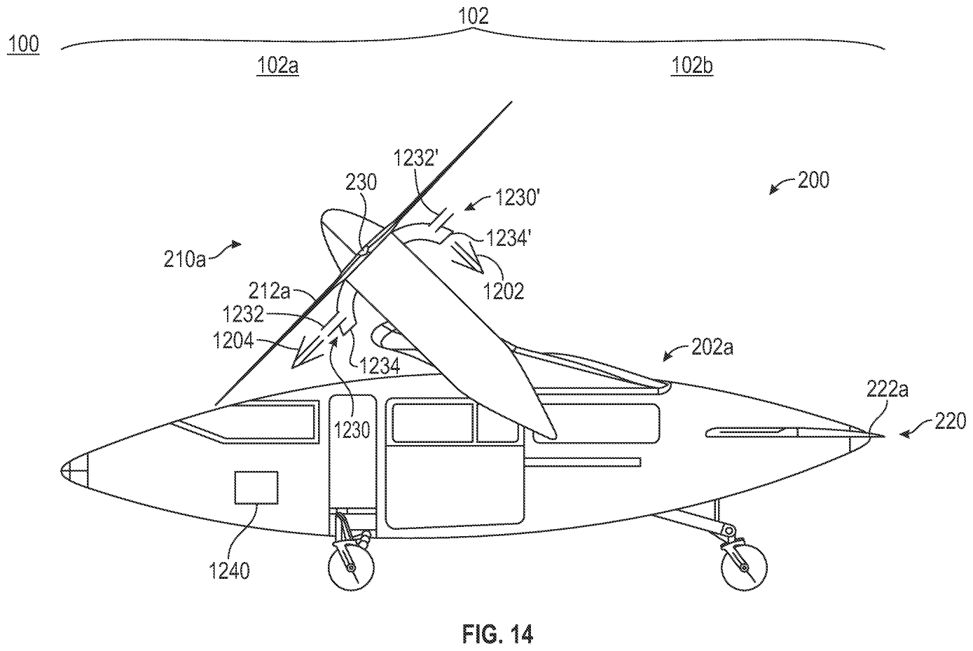

With reference to FIG. 13, the exhaust pipes 1230, 1230′ may include the exhaust outlets 1232, 1232′, 1234, 1234′ configured to direct the airflow 1202, 1204 from the propellors 212a, 212b. While four exhaust outlets 1232, 1232′, 1234, 1234′ are shown, any number may be included. The exhaust outlets 1232, 1232′, 1234, 1234′ may include actuators 1236, 1236′, 1238, 1238′ that cause the airflow 1202, 1204 to be directed out through the exhaust outlets 1232, 1232′, 1234, 1234′ in a direction relative to the engine nacelles 210a, 210b. In aspects, exhaust outlets 1232, 1232′ may be configured as ports (FIG. 14), although a variety of shapes/configurations are envisioned. For example, while only FIG. 14 shows exhaust outlets 1232, 1232′ as straight ports, exhaust outlets 1234, 1234′ may also/alternatively be configured to be ports, as this example is merely illustrative. The exhaust pipes 1230, 1230′ may include rust-resistant metals such as stainless steel and other metals. While the exhaust pipes 1230, 1230′ are shown in a curved shape, any number of alternative shapes may be used.

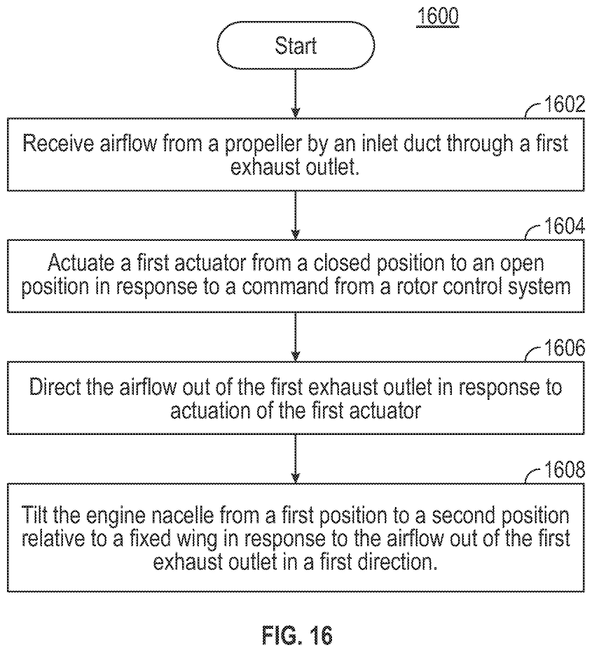

Referring to FIG. 16, a flow diagram for a method 1600 for a tiltrotor rotor tilting system 200 for an aircraft 100 is shown. Although the steps of FIG. 16 are shown in a particular order, the steps need not all be performed in the specified order, and certain steps can be performed in another order. These variations are contemplated to be within the scope of the present disclosure.

Initially, at step 1602, the exhaust outlet 1232, 1232′, 1234, 1234′ receives the airflow 1202, 1204 from the propellor 212a, 212b through the inlet duct 1216. The inlet duct 1216 may be disposed on a front portion of the engine nacelle 210a, 210b, although alternative placements are envisioned. For example, the inlet duct 1216 may receive airflow 1202, 1204, from the propellor through a front or back portion of the engine nacelle 210a, 210b. The exhaust outlet 1232, 1232′, 1234, 1234′ may receive the airflow 1202, 1204 from the inlet duct 1216 through a channel (not shown) in the exhaust pipe 1230, 1230′.

At step 1604, the rotor control system 1240 causes an actuator 1236, 1236′, 1238, 1238′ to actuate from a closed position to an open position. The open position may be configured to permit directing the airflow 1202, 1204 out of an exhaust outlet 1232, 1232′, 1234, 1234′, and the closed position may be configured to prevent directing the airflow 1202, 1204 out of the exhaust outlet 1232, 1232′, 1234, 1234′. In aspects, the rotor control system 1240 may enable actuation through generating a command (e.g., a command in response to a user moving a yoke onboard), although various configurations are envisioned.

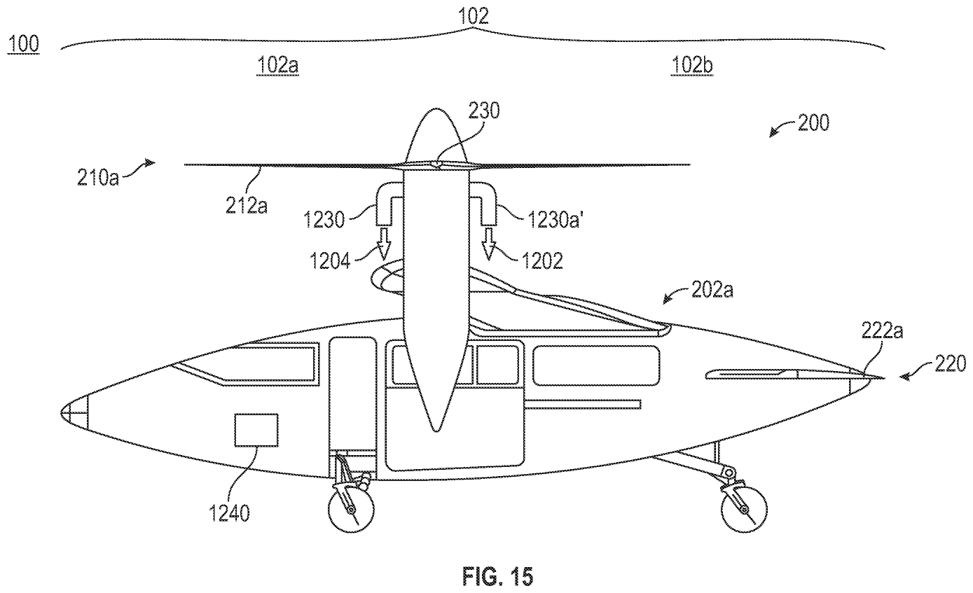

Next, at step 1606, airflow 1202, 1204 is directed out of the exhaust outlet 1232, 1232′, 1234, 1234′ in a first direction in response to actuation of the actuator 1236, 1236′, 1238, 1238′. For example, if actuators 1238, 1238′ actuate from a closed position to an open position, then the airflow 1202, 1204 may be directed out of the exhaust outlets 1234, 1234′ (FIGS. 12, 15). In another example, airflow 1202, 1204 may be directed out of exhaust outlets 1232, 1234 in alternative directions using multiple ports (FIG. 14), or vice versa, although various alternative directions/configurations of airflow between the exhaust outlets 1232, 1232′, 1234, 1234′ are envisioned.

Next, at step 1608, the engine nacelle 210a, 210b tilts from the first nacelle position to the second nacelle position relative to the fixed wing 202a, 202b in response to airflow 1202, 1204 out of the exhaust outlet 1232, 1232′, 1234, 1234′ in the first direction. The engine nacelle 210a, 210b may be configured to tilt in various directions relative to the fixed wing 202a, 202b based on the direction of the airflow 1202, 1204. The direction of airflow 1202, 1204 may be any direction relative to the engine nacelle 210a, 210b. For example, airflow 1202, 1204 may be directed out through the exhaust outlet 1234, 1234′ (e.g., in a direction parallel to the engine nacelle 210a, 210b), causing the engine nacelle 210a, 210b to tilt clockwise from the first nacelle position (FIG. 12) to the second nacelle position (FIG. 15), although various alterative positions/angles may result based on the direction of airflow 1202, 1204 through the exhaust outlet 1232, 1232′, 1234, 1234′.

Various configurations may affect how the engine nacelles 210a, 210b are configured to tilt relative to the fixed wings 202a, 202b. In aspects, the engine nacelles 210a, 210b may be mounted to the fixed wings 202a, 202b by the rotational device 208a, 208b outside of a center of gravity 218a, 218b of the engine nacelles 210a, 210b, resulting in an uneven distribution of weight (i.e., making a front portion or a rear portion of the engine nacelles 210a, 210b heavier), causing the engine nacelles 210a, 210b to rotate into a vertical position (i.e., 90 degree angle, perpendicular relative to the fixed wings 202a, 202b). For example, the engine nacelles 210a, 210b may be mounted to the fixed wings 202a, 202b by the rotational device 208a, 208b on the front portion of the engine nacelles 210a, 210b, causing the rear portion of the engine nacelles 210a, 210b to be heavier and tilt clockwise into the vertical position. In aspects, the position of the rear portion 102b of the fuselage 102 may alter the level of tilt of the engine nacelles 210a, 210b. For example, if the rear portion 102b of the fuselage 102 is at a downward angle, then the engine nacelles 210a, 210b may need to tilt approximately 10 degrees less, resulting in faster and more efficient tilting/flying.

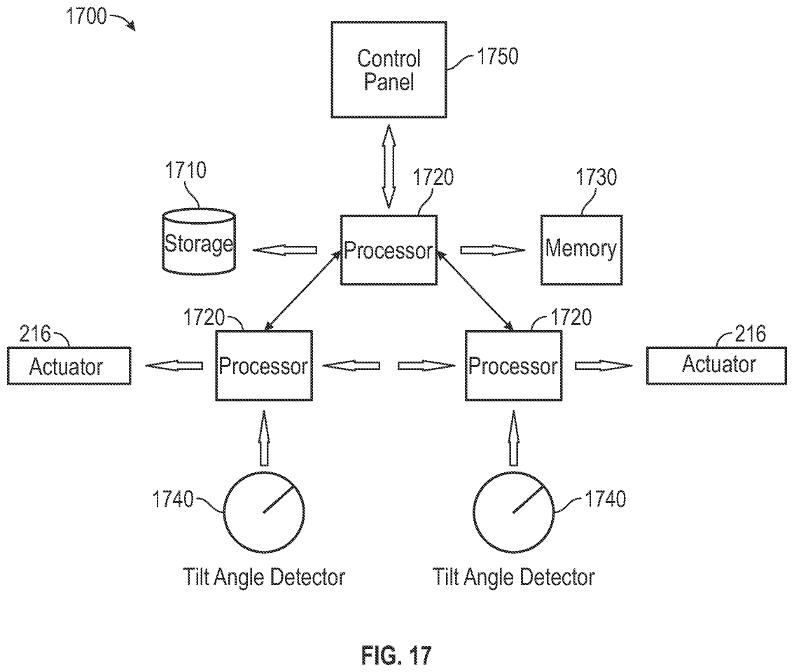

With reference to FIG. 17, the rotor control system 1240 may include a controller 1700. The controller 1700 may include a storage device 1710, processor(s) 1720, and a computer-readable storage medium or a memory 1730. While three processors 1720 are shown in FIG. 17, any suitable number of processors may be used. The processor(s) 1720 may be connected to a control panel 1750 that includes an interface for accepting user input. The interface may be a graphical user interface or physical controls and may generate signals for controlling the aircraft. For example, the interface may include an LCD screen and/or a set of buttons/switches onboard the aircraft 100.

The processor(s) 1720 may also be connected to one or more tilt angle detectors 1740 located in the engine nacelles 210a, 210b, and may be configured to generate a signal indicating the tilt angle of the respective engine nacelle 210a, 210b. The tilt angle detectors 1740 are in electrical communication with the processor(s) 1720. The processor(s) 1720 may be configured to process the signals from the tilt angle detectors 1740 and the control panel 1750 and generate instructions based on the processed signals. For example, the tilt angle detectors 1740 may detect a change in the tilt angles of the engine nacelles 210a, 210b and send signals to the processor(s) 1720. The processor(s) 1720 may process the signals and send instructions to the moveable joints 216 to pivot the engine nacelle flaps 214a, 214a′, 214b, 214b′.

The processor(s) 1720 may be connected to the computer-readable storage medium or memory 1730. The computer-readable storage medium or memory 1730 may be a volatile-type memory, e.g., RAM, or a non-volatile type memory, e.g., flash media, disk media, etc. In various aspects of the present disclosure, the processor(s) 1720 may be another type of processor such as, without limitation, a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the present disclosure, the memory 1730 can be random access memory, read-only memory, magnetic disk memory, solid-state memory, optical disc memory, and/or another type of memory. In some aspects of the disclosure, the memory 1730 can be separate from the controller 1700 and can communicate with the processor(s) 1720 through communication buses of a circuit board and/or through communication cables such as serial ATA cables or other types of cables. The memory 1730 includes computer-readable instructions that are executable by the processor(s) 1720 to operate the controller 1700. The storage device 1710 may be used for storing data.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the present disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with the present disclosure.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances. The aspects described with reference to the attached drawing figures are presented only to demonstrate certain examples of the present disclosure. Other elements, steps, methods, and techniques that are insubstantially different from those described above and/or in the appended claims are also intended to be within the scope of the present disclosure.

What is claimed is:

1. A tiltrotor rotor tilting system for an aircraft, comprising:
a fixed wing;
an engine nacelle rotatably connected to the fixed wing, the engine nacelle including:
a first engine nacelle flap pivotably connected to the engine nacelle; and
a first movable joint configured to pivot the first engine nacelle flap from a stowed flap position to a deployed flap position; and
a propellor operably connected to the engine nacelle by a shaft, the propellor configured to generate airflow,
wherein the engine nacelle is configured to tilt from a first nacelle position to a second nacelle position relative to the fixed wing in response to the airflow contacting the first engine nacelle flap while in the deployed flap position.

2. The tiltrotor rotor tilting system of claim 1, wherein the engine nacelle is rotatably connected to the fixed wing by a rotational device at a center of gravity of the engine nacelle.

3. The tiltrotor rotor tilting system of claim 1, wherein the engine nacelle is rotatably connected to the fixed wing by a rotational device outside of a center of gravity of the engine nacelle, causing the engine nacelle to tilt into a perpendicular position relative to the fixed wing.

4. The tiltrotor rotor tilting system of claim 1, wherein the engine nacelle flap is disposed on an outer surface of the engine nacelle, and wherein in the stowed flap position, the engine nacelle flap is disposed in substantial alignment with the outer surface of the engine nacelle.

5. The tiltrotor rotor tilting system of claim 4, wherein in the deployed flap position, the engine nacelle flap is disposed in substantial unalignment with the outer surface of the engine nacelle.

6. The tiltrotor rotor tilting system of claim 1, wherein the engine nacelle flap is disposed on an inner surface of the engine nacelle, and wherein in the stowed flap position, the engine nacelle flap is retracted substantially within the engine nacelle.

7. The tiltrotor rotor tilting system of claim 6, wherein in the deployed flap position, the engine nacelle flap is expanded substantially outwards from within the engine nacelle.

8. The tiltrotor rotor tilting system of claim 1, further comprising:
a second engine nacelle flap pivotably connected to the engine nacelle; and
a second movable joint configured to pivot the second engine nacelle flap from a stowed flap position to a deployed flap position,
wherein the engine nacelle is configured to tilt from a third nacelle position to a fourth nacelle position relative to the fixed wing in response to the airflow contacting the second engine nacelle flap while in the deployed flap position.

9. A tiltrotor rotor tilting system for an aircraft, comprising:
a fixed wing;
an engine nacelle rotatably connected to the fixed wing, the engine nacelle including:
an inlet duct configured to receive an airflow; and
a first exhaust outlet configured to direct the airflow, the first exhaust outlet including a first actuator disposed in the first exhaust outlet, wherein the first actuator is configured to direct the airflow out of the first exhaust outlet in a first direction; and
a propellor operably connected to the engine nacelle by a shaft, the propellor configured to generate airflow;
a rotor control system configured to actuate the first actuator;
a processor; and
a memory including instructions stored thereon which, when executed by the processor, cause the system to:
receive, by the inlet duct, the airflow from the propellor through the first exhaust outlet;
actuate the first actuator from a closed position to an open position in response to the rotor control system;
direct the airflow out of the first exhaust outlet in the first direction in response to actuation of the first actuator; and
tilt the engine nacelle from a first nacelle position to a second nacelle position relative to the fixed wing in response to the airflow out of the first exhaust outlet in the first direction.

10. The tiltrotor rotor tilting system of claim 9, wherein the engine nacelle is rotatably connected to the fixed wing by a rotational device at a center of gravity of the engine nacelle.

11. The tiltrotor rotor tilting system of claim 9, wherein the engine nacelle is rotatably connected to the fixed wing by a rotational device outside of the center of gravity of the engine nacelle, causing the engine nacelle to tilt into a perpendicular position relative to the fixed wing.

12. The tiltrotor rotor tilting system of claim 9, further comprising a second actuator disposed in the first exhaust outlet, wherein the second actuator is configured to direct the airflow out of the first exhaust outlet in a second direction, and
wherein the instructions, when executed by the processor, further cause the system to:
receive, by the inlet duct, the airflow from the propellor through the first exhaust outlet;
actuate the second actuator from a closed position to an open position in response to the rotor control system;
direct the airflow out of the first exhaust outlet in the second direction in response to actuation of the second actuator; and
tilt the engine nacelle from a third nacelle position to a fourth nacelle position relative to the fixed wing in response to the airflow out of the first exhaust outlet in the second direction.

13. The tiltrotor rotor tilting system of claim 12, further comprising a second exhaust outlet configured to direct the airflow, the second exhaust outlet including a third actuator disposed in the second exhaust outlet, wherein the third actuator configured to direct the airflow out of the second exhaust outlet in a third direction, and
wherein the instructions, when executed by the processor, further cause the system to:
receive, by the inlet duct, the airflow from the propellor through the second exhaust outlet;
actuate the third actuator from a closed position to an open position in response to the rotor control system;
direct the airflow out of the second exhaust outlet in the third direction in response to actuation of the third actuator; and
tilt the engine nacelle from a fifth nacelle position to a sixth nacelle position relative to the fixed wing in response to the airflow out of the second exhaust outlet in the third direction.

14. The tiltrotor rotor tilting system of claim 13, further comprising a fourth actuator disposed in the second exhaust outlet, wherein the fourth actuator is configured to direct the airflow out of the second exhaust outlet in a fourth direction, and
wherein the instructions, when executed by the processor, further cause the system to:
receive, by the inlet duct, the airflow from the propellor through the second exhaust outlet;
actuate the fourth actuator from a closed position to an open position in response to the rotor control system;
direct the airflow out of the second exhaust outlet in the fourth direction in response to actuation of the fourth actuator; and
tilt the engine nacelle from a seventh nacelle position to an eighth nacelle position relative to the fixed wing in response to the airflow out of the second exhaust outlet in the fourth direction.

15. A method for tilting a tiltrotor rotor tilting system for an aircraft, comprising:
receiving, by an inlet duct of an engine nacelle of the aircraft, an airflow from a propellor of the engine nacelle through a first exhaust outlet of the engine nacelle;
actuating a first actuator of the first exhaust outlet from a closed position to an open position in response to a rotor control system;
directing the airflow out of the first exhaust outlet in a first direction in response to actuation of the first actuator; and
tilting the engine nacelle from a first nacelle position to a second nacelle position relative to a fixed wing of the aircraft in response to the airflow out of the first exhaust outlet in the first direction.

16. The method of claim 15, wherein tilting the engine nacelle from the first nacelle position to the second nacelle position includes tilting the engine nacelle using a rotational device, the rotational device rotatably connecting the engine nacelle to the fixed wing at a center of gravity of the engine nacelle.

17. The method of claim 15, wherein tilting the engine nacelle from the first nacelle position to the second nacelle position includes tilting the engine nacelle using a rotational device, the rotational device rotatably connecting the engine nacelle to the fixed wing outside of a center of gravity of the engine nacelle, and
wherein the second nacelle position is a perpendicular position relative to the fixed wing.

18. The method of claim 15, further comprising:
receiving, by the inlet duct, the airflow from the propellor through the first exhaust outlet;
actuating a second actuator from a closed position to an open position in response to the rotor control system;
directing the airflow out of the first exhaust outlet in a second direction in response to actuation of the second actuator; and
tilting the engine nacelle from a third nacelle position to a fourth nacelle position relative to the fixed wing in response to the airflow out of the first exhaust outlet in the second direction.

19. The method of claim 18, further comprising:
receiving, by the inlet duct, the airflow from the propellor through a second exhaust outlet;
actuating a third actuator from a closed position to an open position in response to the rotor control system;
directing the airflow out of the second exhaust outlet in a third direction in response to actuation of the third actuator; and
tilting the engine nacelle from a fifth nacelle position to a sixth nacelle position relative to the fixed wing in response to the airflow out of the second exhaust outlet in the third direction.

20. The method of claim 19, further comprising:
receiving, by the inlet duct, the airflow from the propellor through the second exhaust outlet;
actuating a fourth actuator from a closed position to an open position in response to the rotor control system;
directing the airflow out of the second exhaust outlet in a fourth direction in response to actuation of the fourth actuator; and
tilting the engine nacelle from a seventh nacelle position to an eighth nacelle position relative to the fixed wing in response to the airflow out of the second exhaust outlet in the fourth direction.
